(19) United States
(12) Patent Application Publication
(10) Pub. No.: US 2011/0226709 A1
(43) Pub. Date: Sep. 22, 2011

(54) Combination of Fixture Member for Bicycle and Locking Apparatus for Bicycle Parking Rack

(76) Inventors: Tammy Yen, Taichung (TW); Jan-Nan Chen, Taichung (TW)

(21) Appl. No.: 12/724,488

(22) Filed: Mar. 16, 2010

(51) Int. Cl. E05B 71/00; B62H 5/00; B62K 21/02

(52) U.S. Cl. 211/17; 70/233; 280/276

(57) ABSTRACT

A combination of a front fork of a bicycle and a parking rack, wherein the front fork includes two shafts, each shaft having first and second ends and the parking rack includes a space receiving the front fork for parking the bicycle, the combination comprises a fixture member provided between the first and second ends of one of the shafts and facing opposite to another shaft; and a locking apparatus, which is installed to the parking rack and corresponding to the fixture member, selectively locking the fixture member to the parking rack between a locking position and an unlocking position.

### BACKGROUND OF THE INVENTION

1. Field of the Invention

The present invention relates to locking apparatuses for bicycle parking racks, more particularly, to a combination of a fixture member for a bicycle front fork and a locking apparatus for a bicycle parking rack.

2. Description of the Related Art

Velib, Paris's public bike system is a bid by the city administration to improve the transportation system for Parisians.

However, all bicycles and bicycle parking racks are provided by the public bike system and the bikers cannot park their own bicycles at the public bike system.

The frame of the public bicycle forms with a fixture apparatus which is adapted to couple to the parking rack and the public bike system manages all bicycle parked at the parking racks. The frame of the bicycle cannot be replaced easily so that private bicycles cannot be parked at the public bike system.

### SUMMARY OF THE INVENTION

According to the present invention, it shows a combination of a fixture member for a bicycle front fork and a locking apparatus installed to a bicycle parking rack. The front fork includes two shafts and each shaft has first end and second end. The fixture member is provided at one of the shafts between the first and second ends of the shaft and faces opposite to another shaft. The parking rack includes a space for parking the bicycle and the locking apparatus which is provided to the parking rack corresponds to and selectively locks to the fixture member.

One objective of the present invention is that it is easy to replace the front fork with the fixture member to the front fork of any conventional private bicycle so that the parking rack of the present invention can also park the private bicycle which is attached by the front fork of the present invention.

Other objectives, advantages, and features of the invention will become more apparent from the following detailed description when taken in conjunction with the accompanying drawings.

### BRIEF DESCRIPTION OF THE DRAWINGS

The present invention will be described via detailed illustration of the two embodiments referring to the drawings.

FIG. 1 is a partial, perspective view of a bicycle which is locked with a parking rack with a locking apparatus by a combination of a fixture member installed onto a front fork of the bicycle and the locking apparatus according to the first embodiment of the present invention.

FIG. 2 is an exploded perspective view as shown in FIG. 1.

FIG. 3 is a perspective view of the front fork with the fixture member as shown in FIG. 1.

FIG. 4 is a cross-sectional view of the locking apparatus as shown in FIG. 2, illustrating that the locking apparatus is in a locking position.

FIG. 5 is a cross-sectional view similar to FIG. 4, but illustrating that the locking apparatus is in an unlocking position.

FIG. 6 is another cross-sectional view of the locking apparatus as shown in FIG. 2, illustrating that the locking apparatus is in the unlocking position.

FIG. 7 is a cross-sectional view similar to FIG. 4, but illustrating that the locking apparatus is in the locking position.

FIG. 8 is an exploded perspective view of a front fork with a fixture member according to the second embodiment of the present invention.

FIG. 9 is another exploded perspective view of the front fork with the fixture member as shown in FIG. 8.

FIG. 10 is a side view of the bicycle as shown in FIG. 1, illustrating that the parking rack is fixed to a base plate so that the parking rack can park the bicycle on the ground stably.

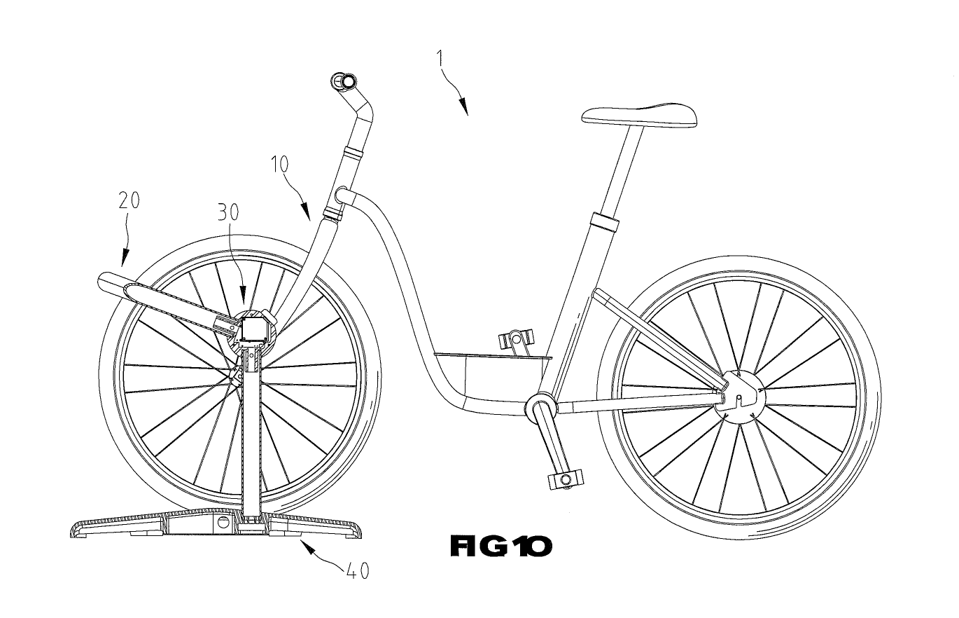

FIG. 11 is a perspective view of numbers of the parking racks as shown in FIG. 10, illustrating that the parking racks park numbers of bicycles.

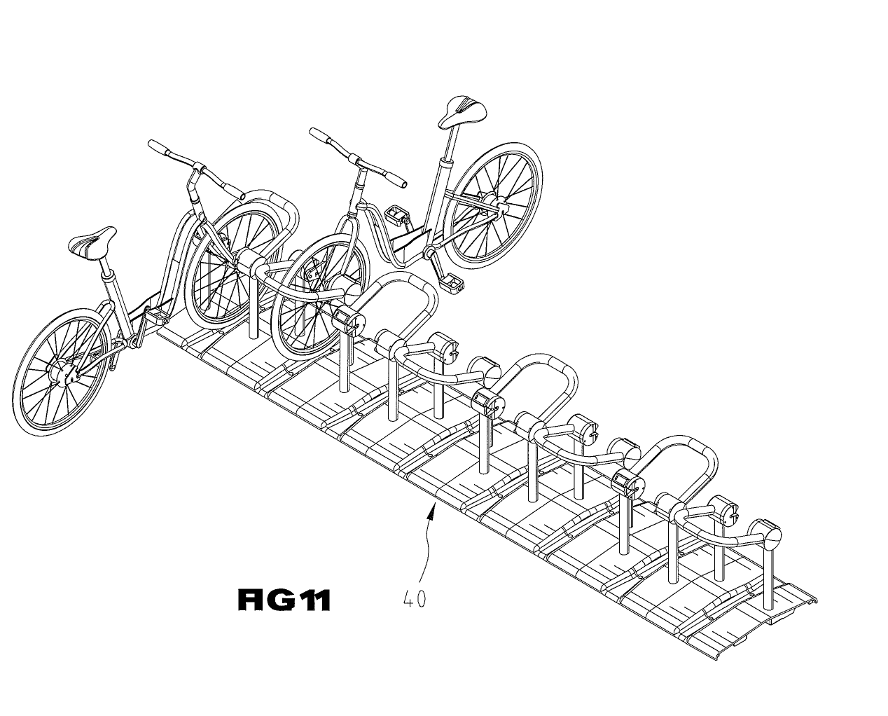

FIG. 12 is a partial, exploded perspective view as shown in FIG. 11, illustrating that each parking rack is fixed to the related base plate via fasteners.

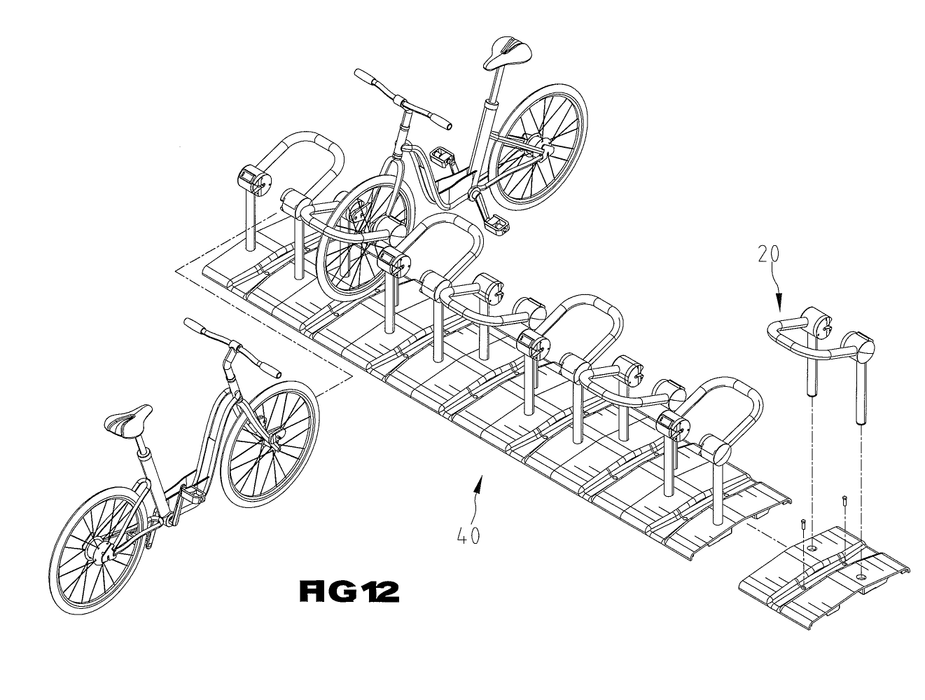

### DETAILED DESCRIPTION OF THE PREFERRED EMBODIMENT

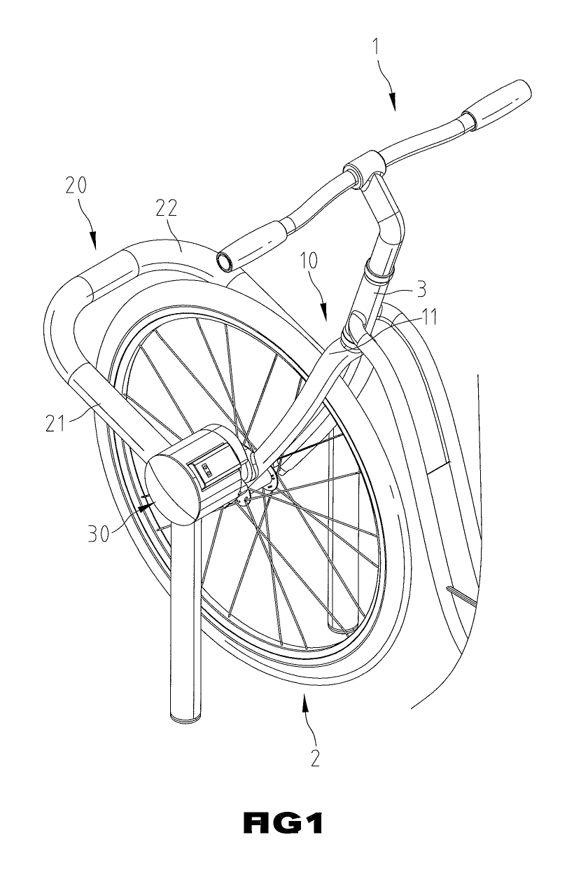

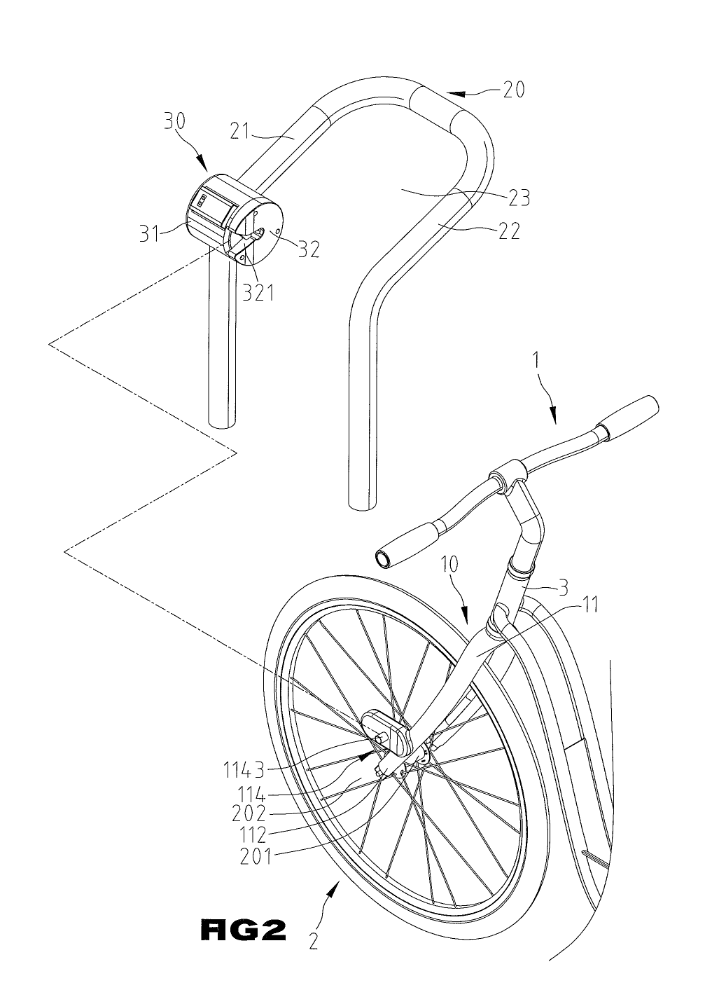

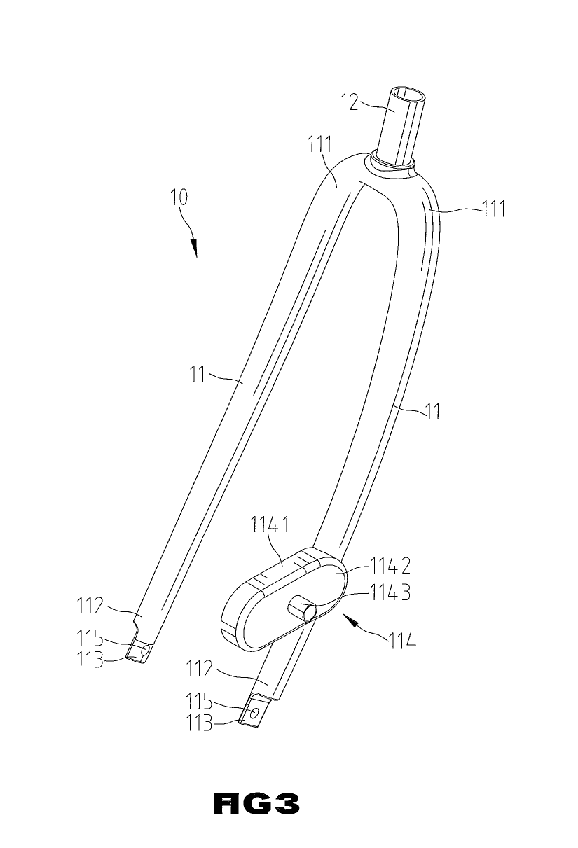

With reference to FIGS. 1 through 7, they show a parking rack 20 parks a bicycle 1 via a locking apparatus 30 which is coupled to a front fork 10 of the bicycle 1 in accordance with a first embodiment of the present invention. The front fork 10 includes two shafts 11 and a connected portion 12. Each shaft 11 has a first end 111 and a second end 112, and two first ends 111 of the shafts 11 are coupled to each other and form with the connected portion 12 which is adapted to connect to a head tube 3 of the bicycle 1. A connected end 113 tapered from the distal end of each second end 112 and an aperture 115 is defined at each connected end 113. The connected ends 113 are adapted to install to two projections 202 of a hub 202 of the bicycle 1 for coupling the front fork 10 to the front wheel 2. A fixture member 114 is provided at one of the shafts 11 between the first and second ends 111, 112 and faces opposite to another shaft 11. In this case, the fixture member 114 is integrally formed onto the related shaft 11. Alternatively, the fixture member 114 can also be detachably installed to the related shaft 11. The fixture member 114 includes a main body 1141, an abutted surface 1142 defined at a side thereof and an engaged element 1143 protruding from the abutted surface 1142. A circuit board is provided at inside of the fixture member 114 and a sensor is installed on the circuit board (not shown). The front fork 10 of the present invention can replace any conventional bicycle front forks so that the fixture member 114 is suitable for any conventional bicycles.

The parking rack 20 is made of one bent shaft and preferably U-shaped. Two distal ends of the parking rack 20 can be fixed on the ground uprightly by cement. The parking rack 20 defines first and second sections 21, 22 continuously and a space 23 adapted to receive the front fork 10 and a front wheel 2 for parking bicycles. The locking apparatus 30 is installed to the first section 21 and corresponds to the fixture member 114. When the fixture member 114 is coupled to the locking apparatus 30, the bicycle 1 is locked to the parking rack 20 inseparably.

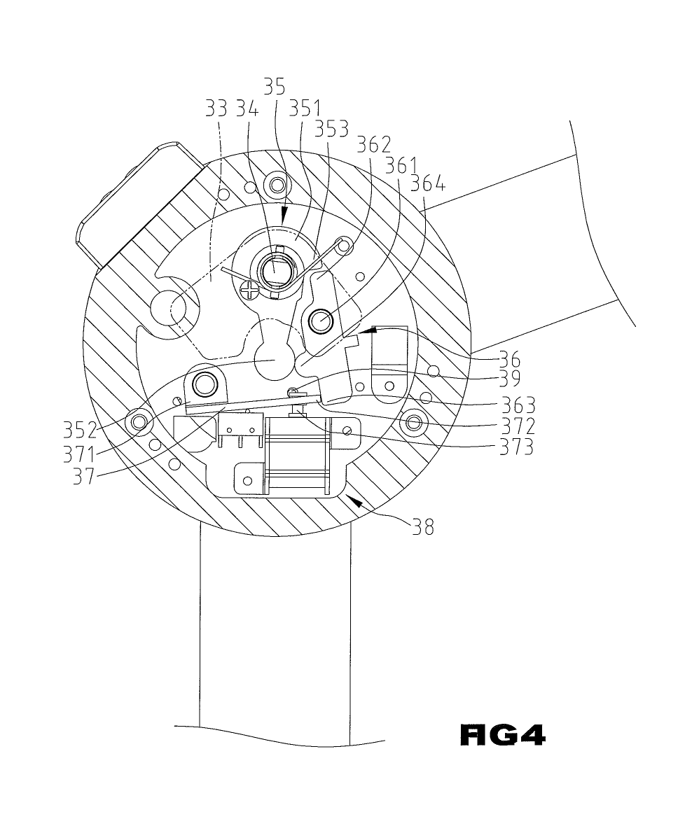

Simultaneously referring to FIGS. 4 through 7, they show that cooperation of the fixture member 14 and the locking apparatus 30 installed to the parking rack 20. To park the bicycle 1 to the parking rack, the front fork 10 would be pushed into the space 23 of the parking rack 20 first, and the fixture member 14 is driven to couple to the locking apparatus 30.

The locking apparatus 30 includes a main body 31 and a locking member 32 coupled to the main body 31 and facing toward the fixture member 114. The locking member 32, in this case, is in form of a circle plate having first side facing the fixture member 114 and second side coupled to the main body 31. A guiding groove 321 which is formed on the first side of the locking member 32 and extends from the center of the locking member 32 toward the periphery of the locking member 32 includes an opening (not numbered) opened to the periphery of the locking member 32 and a hole (not numbered) defined at the center of the first side of the locking member 32. A limited plate 33 is provided between the first and second sides of the locking member 32 and partially exposed from the guiding groove 321. A co-axle 34 is adapted to pivotally install the limited plate 33 to the locking member 32. The limited plate 33, in this case, is preferably L-shaped and includes a receptacle 331 and an inner surface 332 defined on the periphery of the receptacle 331.

The second side of the locking member 32 forms with a first driving member 35 pivotally connected to the co-axle 34 and coaxial to the limited plate 33, a second driving member 36 driven by the first driving member 35, a third driving member 37, a sensor device 38 and a blocked member 39. The first driving member 35 includes a first end 351 pivotally coupled to the co-axle 34 and a second end 352 opposite to the first end 351 and a coupled portion 353 formed on the periphery of the first end 351. A recess 354 is defined between the coupled end 353 and the first end 351. The second driving member 36 is pivotally coupled to the second side of the locking member 32 via a pivotal axle 361 and includes a first end 362, a second end 363 opposite to the first end 362, an abutted portion 364 protruding from a side thereof between the first and second ends 362, 363 and corresponding to the second end 352 of the first driving member 35 and a recess 365 formed on the side thereof and adjacent to the first end 362 and corresponding to the recess 354 of the first driving member 35. The third driving member 37 includes a pivotal end 371 pivotally coupled to the locking member 32, a blocked end 372 opposite to the pivotal end 371 and a controlling element 373 provided on the sensor device 38 between the pivotal end 371 and the blocked end 372. The blocked member 39 is installed on the second side of the locking member 32 and adjacent to the controlling element 373.

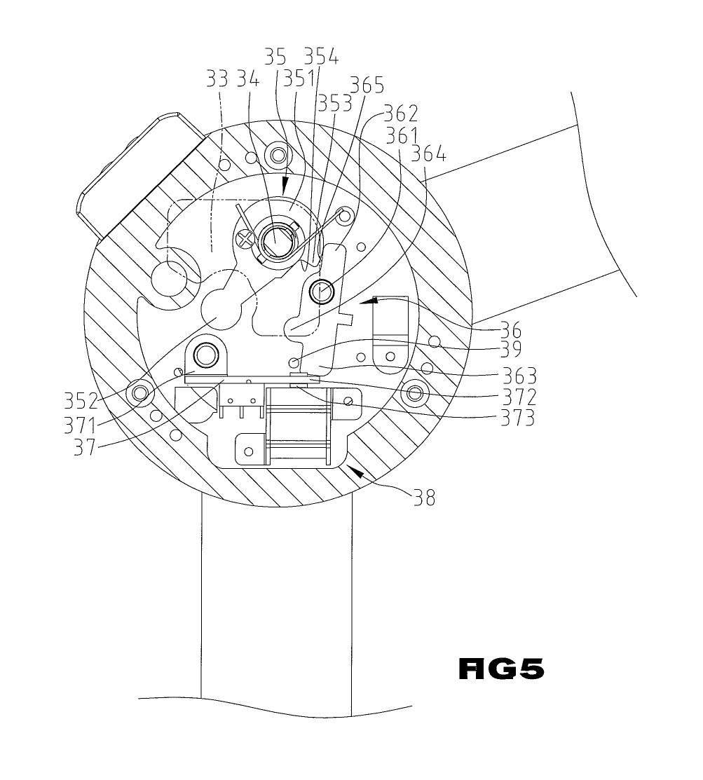

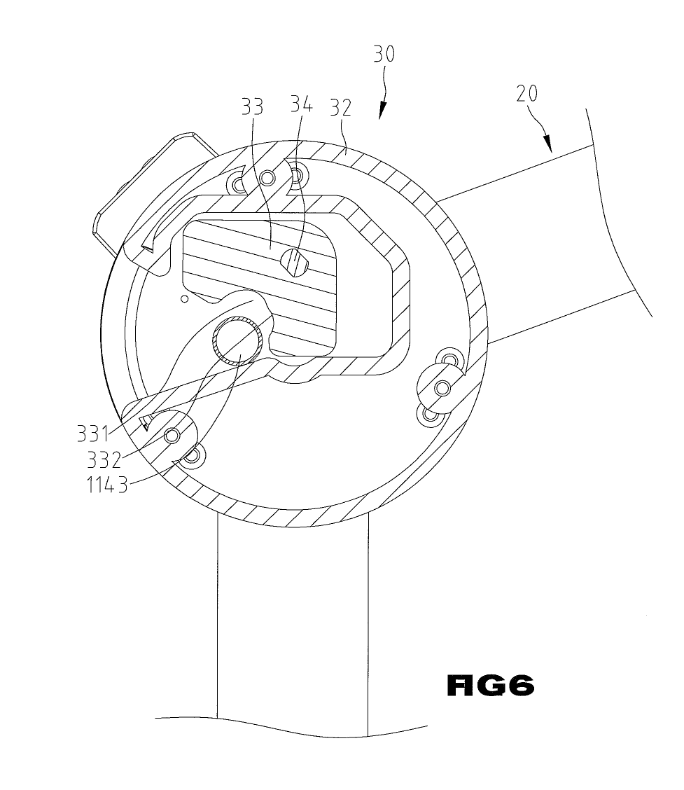

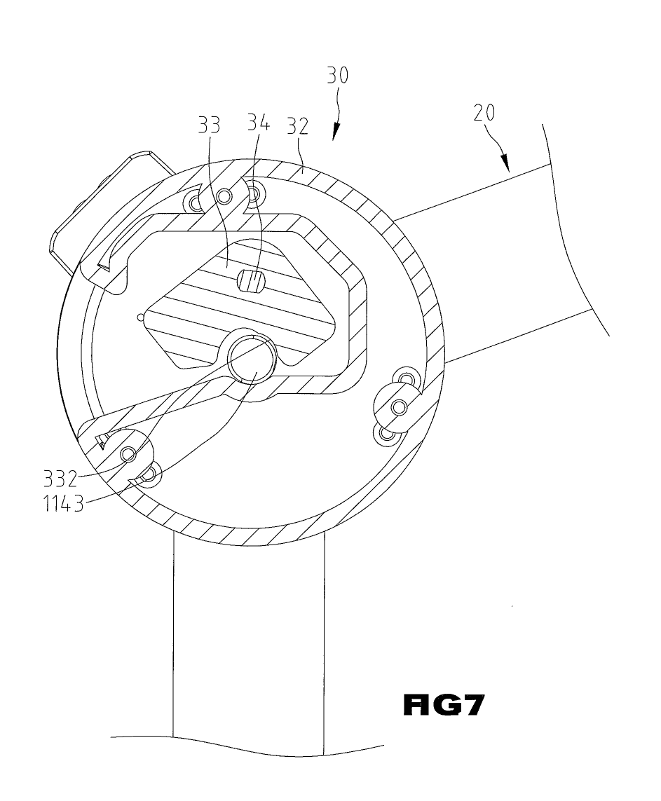

In FIGS. 4 and 5, they respectively show that the locking member 32 is in a locking position and an unlocking position. And further referring to FIG. 6, it show that the engaged element 1143 is inserted into the guiding groove 321 from the opening (not numbered) and is going to engage with the receptacle 331 and abut with the inner surface 332 of the limited plate 33. Referring to FIG. 7, it shows that the engaged element 1143 is abutted against the inner surface 332 and pushes the limited plate 33 to pivot with respect the co-axle 34. In the meanwhile, the first driving member 35 pivots with the limited plate 33 via the co-axle 34.

Before coupling the fixture member 114 and the locking member 32 of the locking apparatus 30 for parking the bicycle 1, the locking member 32 is in the unlocking position as shown in FIG. 5. The coupled portion 353 of the first driving member 35 is provided at the recess 365 of the second driving member 36; the second end 352 of the first driving member 35 is away from the abutted portion 364 of the second driving member 36; the second end 363 of the second driving member 36 presses the controlling element 373 of the third driving member 37 and blocked by the blocked member 39 so that blocked end 372 of the third driving member 37 is pressed toward the sensor member 38. After the engaged element 1143 pushes the limited plate 33 to drive the first driving member 35 to pivot with respect to the co-axle 34. As shown in FIG. 4, the second end 352 of the first driving member 35 is pivoted to push the abutted portion 364 of the second driving member 36 so that the second driving member 36 is driven to pivot with respect to the pivotal axle 361. The coupled portion 353 is detached from the recess 365 of the second driving member 36 and the first end 362 of the second driving member 36 is engaged with the recess 354 of the first driving member 35. And then, the second end 363 of the second driving member 36 does not press the blocked end 372 of the third driving member 37 and away from the controlling element 373. The third driving member 37 pivots with respect to the pivotal end 371 and the distal end of the blocked end 372 block the second end 363 of the second driving member 36 so that the second driving member 36 is blocked by the third driving member 37 and the first driving member 35 is blocked by the second driving member 36 and then the locking member 32 is in the locking position.

When riders want to take the bicycles out of the parking rack 20, the sensor member 38 has to be operated first and the controlling element 373 would drive the third driving member 37 to pivot with respect to the pivotal end 371 to drive the blocked end 372 not to block the second end 363 of the second driving member 36 so that the second driving member 36 pivots with respect to the pivotal axle 361 and the abutted portion 364 pushes the second end 352 of the first driving member 35 to pivot the first driving member 35 till the second end 353 of the second driving member 35 is blocked by the blocked member 39 and the coupled portion 353 of the first driving member 35 is engaged with the recess 365 of the second driving member 36 again. Therefore, the locking member 32 is also back to the unlocking position again.

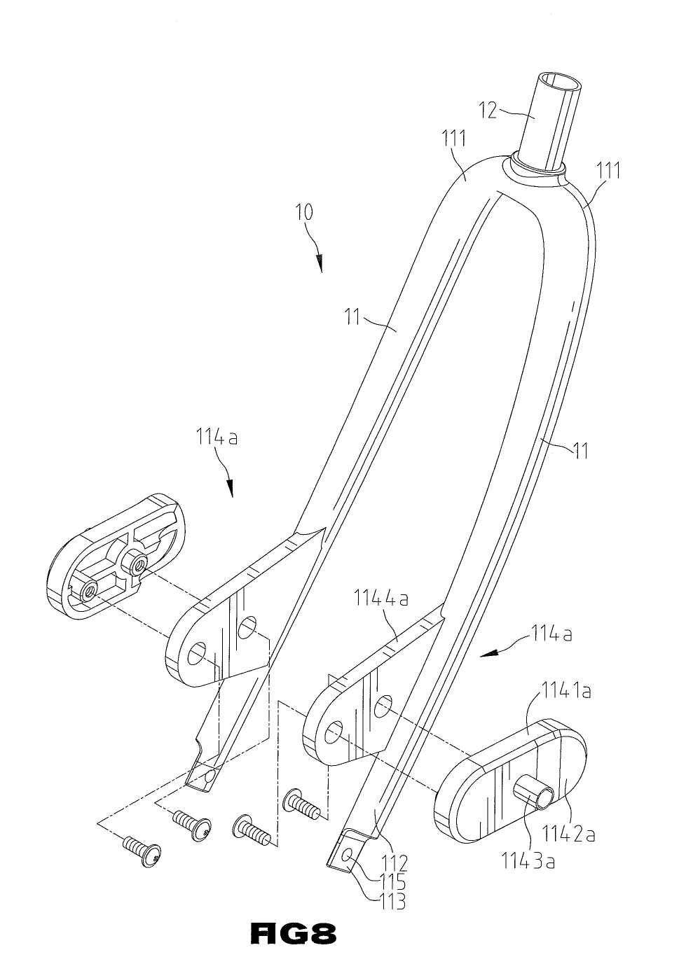

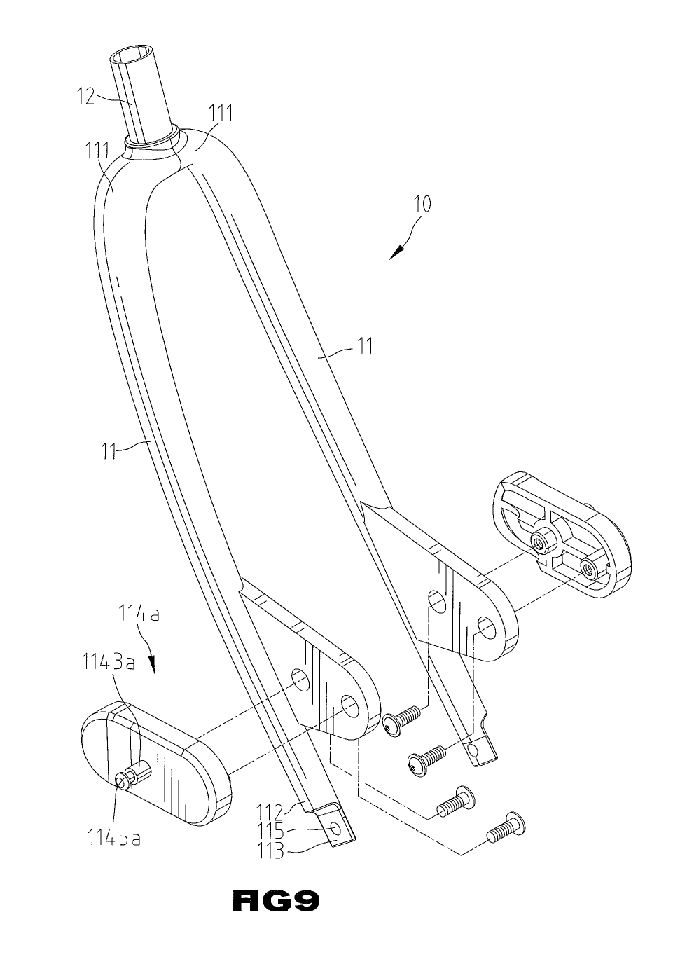

Referring to FIGS. 8 and 9, they show a front fork 10 in accordance with a second embodiment of the present invention is similar to the front fork 10 of the first embodiment but except that two fixture members 114a replace the fixture member 114 and two locking apparatus 30 are provided at the parking rack 20. Each fixture member 114a includes a main body 1141a and a support plate 1144a integrally formed onto the related shaft 11 and coupled to the main body 1141a via at least one fastener (not numbered). An abutted surface 1142a and an engaged element 1143a are respectively defined at the main body 1141a. One of the fixture members 114a includes a circuit board provided at inside thereof and a sensor is installed on the circuit board (not shown). A pin 1145a is provided to insert into the engaged element 1143a of another fixture member 114a. While parking the bicycle 1 which is attached with the front fork 11 with the two fixture members 114a, one fixture member 114a which has the sensor is selectively coupled to the related one locking apparatus 30 between the locking and unlocking positions and another fixture member 114a is adapted to slide to engage with another locking apparatus 30 via the pin 1145a. In this case, the front fork 11 is selectively locked to the parking rack 20 via only one fixture member 114a. However, another fixture member 114a with the pin 1145a just provides to stably park the bicycle 1 to the parking rack 20.

While several embodiments of the invention have been shown and described, it will be apparent to those skilled in the art that modifications may be made therein without departing from the scope and spirit of the present invention.

What is claimed is:

1. A combination of a front fork of a bicycle and a parking rack, wherein the front fork includes two shafts, each shaft having first and second ends and the parking rack includes a space receiving the front fork for parking the bicycle, the combination comprising:
at least one fixture member provided between the first and second ends of one of the shafts and facing opposite to another shaft; and
at least one locking apparatus, which is installed to the parking rack and corresponding to the fixture member, selectively locking the fixture member to the parking rack between a locking position and an unlocking position.

2. The combination as claimed in claim 1 wherein the locking apparatus includes a locking member having a guiding groove for the fixture member coupled thereto, a limited plate partially exposed from the guiding groove, first, second and third driving members, a co-axle coaxially coupling the first driving member and the limited plate to the locking member and a sensor member; wherein the locking apparatus is selectively driven to move between the locking position and the unlocking position; wherein when the fixture member is coupled to the guiding groove and drives the limited plate to pivot with respect to the co-axle, the first driving member is driven to pivot and pushes the second driving member so that the first driving member is blocked by the second driving member and the second driving member is blocked by the third driving member for driving the locking apparatus to the locking position; wherein while the sensor member is operated by riders, the second driving member is not blocked by the third driving member and pushes the first driving member to pivot with respect to the co-axle for driving the locking apparatus to be back to the unlocking position and releasing the bicycle from the parking rack.

3. The combination as claimed in claim 2 wherein the fixture member includes an engaged element and the limited plate includes a receptacle, with the engaged element adapted to engage with the receptacle for pushing the limited plate.

4. The combination as claimed in claim 2 wherein the first driving member includes a first end pivotally coupled to the co-axle and a second end opposite to the first end and a coupled portion formed on the periphery of the first end; wherein the second driving member is pivotally coupled to the locking member via a pivotal axle and includes a first end, a second end opposite to the first end, and an abutted portion corresponding to the second end of the first driving member; wherein the third driving member includes a pivotal end pivotally coupled to the locking member, a blocked end opposite to the pivotal end and a controlling element provided on the sensor device between the pivotal end and the blocked end.

5. The combination as claimed in claim 4, wherein a blocked member is installed on the locking member and adjacent to the controlling element and selectively blocks the second end of the second driving member.

6. The combination as claimed in claim 1 wherein the front fork includes two fixture members and two locking apparatus are provides at the parking rack and correspond to the fixture members respectively; with one of the fixture members having a sensor and another fixture member having a pin for stably parking the bicycle.

7. The combination as claimed in claim 5 wherein the second end of the first driving member is pivoted to push the abutted portion of the second driving member; wherein the second driving member is driven to pivot with respect to the pivotal axle; wherein the second end of the second driving member does not press the blocked end of the third driving member and away from the controlling element; wherein the third driving member pivots with respect to the pivotal end and the distal end of the blocked end blocks the second end of the second driving member; wherein the second driving member is blocked by the third driving member and the first driving member is blocked by the second driving member, with the locking member is in the locking position

8. The combination as claimed in claim 7 wherein when the sensor member has to be operated for driving the locking apparatus to be the unlocking position, the controlling element drives the third driving member to pivot with respect to the pivotal end to drive the blocked end not to block the second end of the second driving member; wherein the second driving member pivots with respect to the pivotal axle and the abutted portion pushes the second end of the first driving member to pivot the first driving member till the second end of the second driving member is blocked by the blocked member, with the locking member being back to the unlocking position again.

9. A parking rack which has a space receiving a front fork of a bicycle for parking the bicycle, the parking rack comprising:
a locking apparatus, which is installed to the parking rack selectively locking the front fork to the parking rack between a locking position and an unlocking position.

10. The parking rack as claimed in claim 9, wherein the front fork includes two shafts, each shaft having first and second ends, and at least one fixture member provided between the first and second ends of one of the shafts and facing opposite to another shaft; wherein the locking apparatus corresponds to the fixture member, selectively locking the fixture member to the parking rack between a locking position and an unlocking position.

11. The parking rack as claimed in claim 10 wherein the locking apparatus includes a locking member having a guiding groove for the fixture member coupled thereto, a limited plate partially exposed from the guiding groove, first, second and third driving members, a co-axle coaxially coupling the first driving member and the limited plate to the locking member and a sensor member; wherein the locking apparatus is selectively driven to move between the locking position and the unlocking position; wherein when the fixture member is coupled to the guiding groove and drives the limited plate to pivot with respect to the co-axle, the first driving member is driven to pivot and pushes the second driving member so that the first driving member is blocked by the second driving member and the second driving member is blocked by the third driving member for driving the locking apparatus to be the locking position; wherein while the sensor member is operated by riders, the second driving member is not blocked by the third driving member and pushes the first driving member to pivot with respect to the co-axle for driving the locking apparatus to be back to the unlocking position and releasing the bicycle from the parking rack.

12. The parking rack as claimed in claim 11 wherein the fixture member includes an engaged element and the limited plate includes a receptacle, with the engaged element adapted to engage with the receptacle for pushing the limited plate.

13. The parking rack as claimed in claim 11 wherein the first driving member includes a first end pivotally coupled to the co-axle and a second end opposite to the first end and a coupled portion formed on the periphery of the first end; wherein the second driving member is pivotally coupled to the locking member via a pivotal axle and includes a first end, a second end opposite to the first end, and an abutted portion corresponding to the second end of the first driving member; wherein the third driving member includes a pivotal end pivotally coupled to the locking member, a blocked end opposite to the pivotal end and a controlling element provided on the sensor device between the pivotal end and the blocked end.

14. The parking rack as claimed in claim 13, wherein a blocked member is installed on the locking member and adjacent to the controlling element and selectively blocks the second end of the second driving member.

15. The parking rack as claimed in claim 9 wherein the front fork includes two fixture members and two locking apparatus are provides at the parking rack and correspond to the fixture members respectively; with one of the fixture members having a sensor and another fixture member having a pin for stably parking the bicycle.

16. The parking rack as claimed in claim 13 wherein the second end of the first driving member is pivoted to push the abutted portion of the second driving member; wherein the second driving member is driven to pivot with respect to the pivotal axle; wherein the second end of the second driving member does not press the blocked end of the third driving member and away from the controlling element; wherein the third driving member pivots with respect to the pivotal end and the distal end of the blocked end blocks the second end of the second driving member; wherein the second driving member is blocked by the third driving member and the first driving member is blocked by the second driving member, with the locking member in the locking position

17. The parking rack as claimed in claim 16 wherein when the sensor member has to be operated for driving the locking apparatus to the unlocking position, the controlling element drives the third driving member to pivot with respect to the pivotal end to drive the blocked end not to block the second end of the second driving member; wherein the second driving member pivots with respect to the pivotal axle and the abutted portion pushes the second end of the first driving member to pivot the first driving member till the second end of the second driving member is blocked by the blocked member, with the locking member being back to the unlocking position again.

18. A front fork of a bicycle for coupling to a parking rack and parking the bicycle, the front fork comprising:
two shafts, each shaft having first and second ends;
at least one fixture member provided between the first and second ends of one of the shafts and facing opposite to another shaft, and with the fixture member having an engaged element protruding therefrom for coupling to the parking rack.

19. The front fork as claimed in claim 18 wherein the parking rack includes a space receiving the front fork for parking the bicycle and at least one locking apparatus, which is installed to the parking rack and corresponding to the fixture member, selectively locking the fixture member to the parking rack between a locking position and an unlocking position; wherein the locking apparatus includes a locking member having a guiding groove for the fixture member coupled thereto, a limited plate partially exposed from the guiding groove, first, second and third driving members, a co-axle coaxially coupling the first driving member and the limited plate to the locking member and a sensor member; wherein the locking apparatus is selectively driven to move between the locking position and the unlocking position; wherein when the fixture member is coupled to the guiding groove and drives the limited plate to pivot with respect to the co-axle, the first driving member is driven to pivot and pushes the second driving member so that the first driving member is blocked by the second driving member and the second driving member is blocked by the third driving member for driving the locking apparatus to be the locking position; wherein while the sensor member is operated by riders, the second driving member is not blocked by the third driving member and pushes the first driving member to pivot with respect to the co-axle for driving the locking apparatus to be back to the unlocking position and releasing the bicycle from the parking rack.

20. The combination as claimed in claim 19 wherein the first driving member includes a first end pivotally coupled to the co-axle and a second end opposite to the first end and a coupled portion formed on the periphery of the first end; wherein the second driving member is pivotally coupled to the locking member via a pivotal axle and includes a first end, a second end opposite to the first end, and an abutted portion corresponding to the second end of the first driving member; wherein the third driving member includes a pivotal end pivotally coupled to the locking member, a blocked end opposite to the pivotal end and a controlling element provided on the sensor device between the pivotal end and the blocked end; wherein a blocked member is installed on the locking member and adjacent to the controlling element and selectively blocks the second end of the second driving member.
